(19) United States
(12) Patent Application Publication
(10) Pub. No.: US 2003/0013501 A1
(43) Pub. Date: Jan. 16, 2003

(54) Apparatus for hands free operation of a mobile telephone

(76) Inventor: Ron Malhotra, Hauppauge, NY (US)

Correspondence Address: Jean-Marc Zimmerman, 226 St. Paul Street, Westfield, NJ, 07090, US

(21) Appl. No.: 09/904,309

(22) Filed: Jul. 12, 2001

(51) Int. Cl. H04M 1/00

(52) U.S. Cl. 455/569; 455/550

(57) ABSTRACT

A device for hands-free operation of a mobile telephone in an automobile, wherein the device is coupled to a mobile telephone and to an automobile amplifier. The device includes an amplifier for amplifying signals received by the mobile telephone and transmitting the signals through an automobile power source to the automobile amplifier for broadcast over an automobile audio speaker. The device also includes a microphone for enabling the driver to speak over the mobile telephone without having to hold the phone.

### FIELD OF THE INVENTION

The present invention pertains to the field of mobile telephones and more particularly to a device that permits hands-free operation of a phone so that calls can be heard on an automobile radio speaker.

### BACKGROUND OF THE INVENTION

Mobile telephones are widely used throughout the world today. The portability and convenience of such phones has resulted in their being widely used by persons driving automobiles. However, using a phone while driving an automobile can be dangerous. Specifically, drivers are often distracted when operating or searching for their phone such that they do not pay attention to their driving which can result in an accident that maims and kills. In addition, using one hand to operate a phone and one hand to operate a vehicle can also result in an accident. Such accidents are becoming more commonplace and have prompted many municipalities, counties, states and even Congress to pass or propose laws that would make it illegal to use mobile telephones while driving an automobile.

To lessen the dangers associated with operating a mobile telephone while driving, hands-free devices have been developed that enable drivers to operate such phones without having to physically hold the phone. Examples of such devices are found in U.S. Pat. No. 6,108,567 to Hosonuma which discloses a radio communication apparatus having a hands-free communication capability, wherein when the apparatus is connected to a power source, e.g. car cigarette lighter, it enables the hands-free operation of a phone, and also in U.S. Pat. No. 6,134,456 to Chen which discloses an integrated mobile-phone hands-free kit to enable hands-free communications of a phone over an automobile's stereo loudspeakers, wherein the kit integrates the power supply of the mobile-phone hands-free kit together with that of an existing vehicular system.

A drawback of such conventional devices is that they are relatively complicated to use/install and/or are expensive. Accordingly, it is an object of the present invention to provide a device that enables hands-free operation of mobile telephones that is less complicated to use/install and less expensive than conventional devices.

### SUMMARY

A device for hands-free operation of a mobile telephone in an automobile, wherein the device is coupled to a mobile telephone and to an automobile power source, i.e., cigarette lighter outlet. The device includes an amplifier to amplify the signals received by the mobile telephone and transmits, the amplified signals through the automobile power source to an automobile amplifier for broadcast over an automobile audio speaker. The device also includes a microphone that enables the driver to speak over the mobile telephone without having to hold the phone.

### BRIEF DESCRIPTION OF THE DRAWINGS

FIG. 1 shows a diagram of an exemplary embodiment of a device for hands-free operation of a mobile telephone in an automobile according to the present invention.

FIG. 2 shows a flowchart depicting the steps by which the device shown in FIG. 1 broadcasts signals received by the mobile telephone over an automobile's audio speaker(s).

FIG. 3 shows a flowchart depicting the steps by which the device shown in FIG. 1 transmits words spoken in the auto-mobile over the mobile telephone.

### DETAILED DESCRIPTION OF THE INVENTION

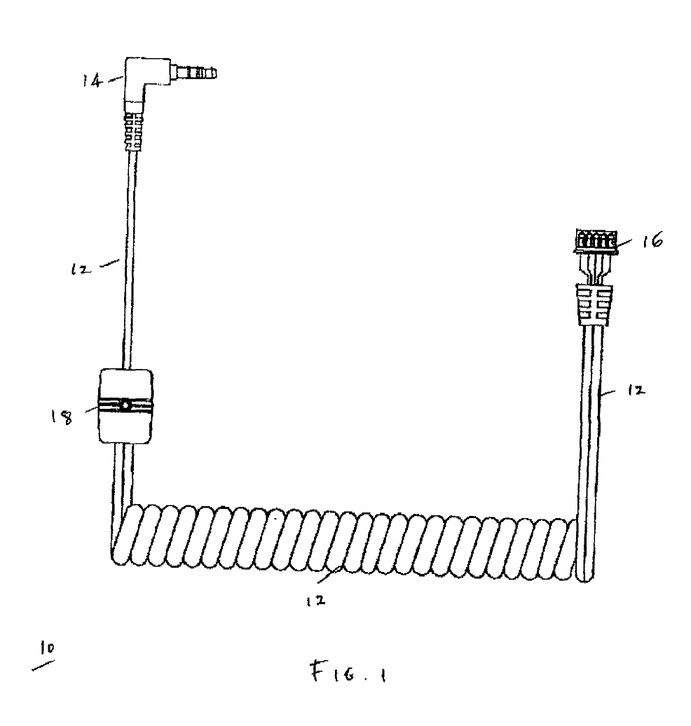

FIG. 1 shows a diagram of an exemplary embodiment of a device 10 for hands-free operation of a mobile telephone in an automobile according to the present invention. Device 10 is comprised of: a means 12 along which a signal, e.g., a telephone call or a word spoken in the automobile, propagates and/or is transmitted; a first connector 14 coupled to one end of means 12; a second connector 16 coupled to the other end of means 12; and a combination amplifier/microphone 18 coupled to means 12 at a point between the first and second ends thereof. Alternatively, the amplifier and the microphone components of amplifier/microphone 18 can be implemented as separate components coupled to means 12.

First connector 14 is used to connect device 10 to a mobile telephone, and second connector 16 is used to connect device 10 to a power source, i.e., cigarette lighter outlet in an automobile. Second connector 16 is a battery eliminator cigarette lighter adapter plug that is inserted into the cigarette lighter of an automobile. Device 10 is easy to use, only requiring that connector 14 and 16 be coupled to the driver's mobile telephone and the automobile's cigarette lighter outlet, respectively. Also, the driver's phone should ideally be placed in a cradle or other holder where it can rest securely so that it is easily accessible and does not move about the interior of the auto mobile.

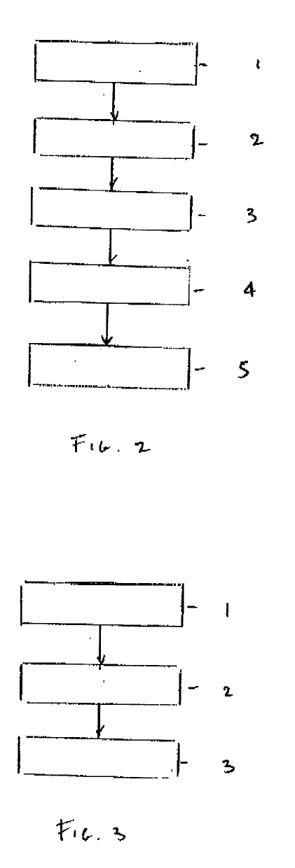

FIG. 2 shows a flowchart depicting the steps by which device 10 broadcasts a call received by the driver's mobile telephone over an automobile's speaker(s) without the driver having to hold the phone. At step 1, the driver's phone receives a call, i.e., signal, from another telephone. At step 2, the driver's phone transmits the received signal to device 10. At step 3, amplifier/microphone 18 amplifies the signal. Amplifier/microphone 18 also controls the attenuation of this signal. At step 4, device 10 transmits the amplified signal over means 12 to the automobile's amplifier at a frequency of 88.7 Mhz or 106.5 Mhz. At step 5, the automobile's amplifier amplifies the signal and transmits the signal to the automobile's audio speaker(s) over which it is broadcast, thereby enabling the driver to hear the call without having to hold the phone.

FIG. 3 shows a flowchart depicting the steps by which device 10 operates to enable a driver to talk over the mobile telephone without having to hold the phone. At step 1, amplifier/microphone 18 of device 10 detects a word, i.e., a signal, spoken by the driver. At step 2, amplifier/microphone 18 amplifies the signal and transmits it over means 12 to the driver's telephone. At step 3, the driver's telephone transmits the signal to another phone being used by a person to whom the driver is speaking.

Ideally, device 10 will be used with a voice-activated mobile telephone so that the driver can use the phone, e.g., dial a phone number, respond to a call, and end a call, without having to touch the phone, thereby permitting totally hands-free operation of the phone. However, device 10 can also be used with conventional phones that require the driver to press a button or buttons to be used. However, irrespective of the type of phone, use of device 10 will add to the safety of drivers and other motorists by reducing (and in some cases eliminating) the need for the driver to hold the phone when they are using it while they drive.

The present invention can be used with any type of mobile telephone, i.e., cellular phone, satellite phone, etc. Similarly, device 10 can be fabricated to operate at frequencies other than 88.7 Mhz and 106.5 Mhz. Device 10 can also be used in vehicles other than automobiles, such as a truck or boat. In addition, device 10 can be used for hands-free operation of a mobile phone in environments where a cigarette lighter outlet or similar power source is available, such as in a home or an office.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A device for hands-free operation of a mobile telephone, comprising:
means over which a signal can propagate, the means having a first end and a second end, the first end being configured for coupling to a mobile telephone and the second end being configured for coupling to an automobile amplifier, the means further comprising a hands-free amplifier for amplifying a signal received by the mobile telephone, the means transmitting the amplified signal to the automobile amplifier for broadcast over a speaker in the automobile, thereby enabling the driver to hear the signal without having to hold the mobile telephone.

2. The device according to claim 1, wherein the second end is a cigarette lighter adapter plug.

3. The device according to claim 2, wherein the plug is coupled to an automobile cigarette lighter outlet.

4. The device according to claim 1, wherein the second end is coupled to a power source.

5. The device according to claim 1, wherein the device transmits the amplified signal over the means to the automobile amplifier at a frequency of 88.7 Mhz.

6. The device according to claim 1, wherein the device transmits the amplified signal over the means to the automobile amplifier at a frequency of 106.5 Mhz.

7. The device according to claim 1, wherein the automobile amplifier amplifies the signal received from the means and broadcasts the signal over the automobile speaker.

8. The device according to claim 1, wherein the device includes a microphone that detects a word spoken by the driver, thereby enabling the driver to speak over the mobile telephone without holding the mobile telephone.

9. The device according to claim 8, wherein the hands-free amplifier amplifies the word spoken by the driver and transmits the word over the means to the mobile telephone.

10. The device according to claim 9, wherein the mobile telephone then transmits the signal to another telephone.

11. A device for hands-free operation of a mobile telephone comprising:
means for receiving a signal from a mobile telephone, amplifying the signal and transmitting the signal to an automobile, wherein the signal is broadcast over an automobile audio speaker, thereby enabling the driver to hear a telephone call without having to hold the mobile telephone.

12. The device according to claim 11, wherein the device is coupled to an automobile power source.

13. The device according to claim 12, wherein the device is coupled to the automobile power source by a cigarette lighter adapter plug.

14. The device according to claim 12, wherein the power source is a cigarette lighter outlet.

15. The device according to claim 11, wherein the device includes a microphone into which the driver can speak without having to hold the mobile telephone, thereby enabling the driver to speak during the telephone call without holding the mobile telephone.

16. The device according to claim 15, wherein the means amplifies a word spoken by the driver.

17. The device according to claim 16, wherein the means transmits the amplified word to the mobile telephone for transmission to another telephone being used by a person to whom the driver is speaking.

18. The device according to claim 16, wherein the means employs an amplifier to amplify both the signal received by the mobile telephone and the word spoken by the driver.

19. The device according to claim 11, wherein the device transmits the amplified signal over the means to an automobile amplifier at a frequency of 88.7 Mhz.

20. The device according to claim 11, wherein the device transmits the amplified signal over the means to an automobile amplifier at a frequency of 106.5 Mhz.
